(19) United States
(12) Patent Application Publication
(10) Pub. No.: US 2018/0109084 A1
(43) Pub. Date: Apr. 19, 2018

(54) WIRE SHEAR ANVIL TOOL

(71) Applicant: Dennis K. Smith, Anderson, CA (US)

(72) Inventor: Dennis K. Smith, Anderson, CA (US)

(21) Appl. No.: 15/294,964

(22) Filed: Oct. 17, 2016

(51) Int. Cl. H02G 1/00; B23D 29/00

(52) U.S. Cl. CPC H02G 1/005; B23D 29/002

(57) ABSTRACT

A portable wire shear anvil tool is disclosed having a main body, a threaded plunger with a shear plunger at one end, a movable upper shear blade, and a lower shear blade or anvil fixed in place. Upon actuation of the wire shear anvil tool, the tool is adapted to engage and to shear a wire, which can be of differing diameters.

### FIELD OF THE INVENTION

The present invention relates to a wire shear anvil tool. More particularly the invention relates to a wire shear anvil tool that is portable and can alternatively be affixed to a support structure or handheld.

### BACKGROUND OF THE INVENTION

Wire shear tools are known in the art. While there are many types of shear tools, a basic shear process involves the application of significant pressure by a moving blade pushing a wire to be cut against a fixed blade. Shearing can be used with wires of differing diameters and should occur with essentially no loss of material. However, shearing can result in end deformation if the blades are not securely held in place or separation occurs between the blades. It is important that the cutting occurs at a right angle to avoid frayed edges in the cut wire. Frayed edges, in addition to being sharp, result in a loss in conductivity in the wire. Thus, many shear tools have shortcomings including (1) the tools are not versatile in use; (2) the tools due to bulkiness are not adapted for use in remote locations or field repair work; (3) manual tools result in rocking or bending of the wires resulting in a bad cut; and (4) similar problems.

Accordingly, a compact, reliable, uncomplicated wire shear tool useful with only the application of minimal or moderate manual force would be beneficial. These and other advantages are provided by the present invention.

### SUMMARY OF THE INVENTION

The present invention provides a wire shear anvil tool that is portable and can be, alternatively, handheld or affixed to a support structure, such as a work bench or vise.

The present invention also provides a wire shear anvil tool that allows a user to take and use the tool into tight places that are difficult or impossible to use with conventional handheld wire shear tools and achieve a clean cut of a wire.

The wire shear anvil tool of the invention is designed to be used with wires of different diameters and to accommodate a ratchet or extension, e.g., ⅜ inch ratchet and/or a ⅜ inch extension, or impact drill to move a threaded plunger with a shear plunger to close an upper shear blade and a lower shear blade or anvil on a wire to shear the wire at a proper angle to provide a clean cut.

The wire shear anvil tool of the present invention comprises a main body, a threaded plunger with a shear plunger at one end, an upper shear blade received in and held by the shear plunger, and a lower shear blade or anvil held in place by a lock piece in the main body. A support bracket may be used with the tool to hold the tool in a fixed position.

The above structures and benefits of the invention will be apparent from the following description of preferred embodiments of the invention and from the accompanying drawings.

### BRIEF DESCRIPTION OF THE DRAWINGS

The following detailed description of the specific non-limiting embodiments of the present invention can be best understood when read in conjunction with the following drawings.

Referring to the drawings:

FIG. 1 shows a perspective view of the wire shear anvil tool of the invention, with the upper shear blade and the lower shear blade or anvil shown in a closed or adjacent position, such as occurs following actuating the shear plunger to move the upper shear blade downward to apply force to a wire to be cut (not shown) when passing between the upper and lower blades.

FIG. 1A is the same view as in FIG. 1, but showing the threaded plunger Ln a raised position and the upper shear blade and lower shear blade in an open or spaced apart position, such as to allow the insertion of a wire to be cut (shown in dashed lines).

FIG. 2 shows a first side view of the wire shear anvil tool of FIG. 1.

FIG. 3 shows a rear view of the wire shear anvil tool of FIG. 1.

FIG. 4 shows a second side view (i.e., the side opposite the first side shown in FIG. 2) of the wire shear anvil tool of FIG. 1.

FIG. 5 shows a bottom perspective view of the wire shear anvil tool of FIG. 1.

FIG. 6 shows a cross-section of the main body of the wire shear anvil tool of FIG. 1 taken along line 6-6 of FIG. 8.

FIG. 7 shows a top view of the main body shown in FIG. 6.

FIG. 8 shows a front view of the main body shown in FIG. 6.

FIG. 9 shows a partially cut-away side view of the threaded plunger of the wire shear anvil tool of FIG. 1.

FIG. 10 shows a top view of the threaded plunger of FIG. 9.

FIG. 11 shows a side view of the shear plunger, which is received in the threaded plunger of FIG. 9, which receives the upper shear blade of the wire shear anvil tool of FIG. 1.

FIG. 12 shows a bottom view of the shear plunger of FIG. 11.

FIG. 13 shows a lock piece for the lower shear blade of the wire shear anvil tool of FIG. 1.

FIG. 14 shows a front view of the lock piece shown in FIG. 13, wherein a fastener-receiving passage through the lock piece is shown in dashed lines.

FIG. 15 shows a perspective view of the lower shear blade or anvil of the wire shear anvil tool of FIG. 1.

FIG. 16 shows a perspective view of the upper shear blade of the wire shear anvil tool of FIG. 1.

FIG. 17 shows a perspective view of one embodiment of a support bracket useful with the wire shear anvil tool of FIG. 1.

FIG. 18 shows a front view of the support bracket of FIG. 17.

### DETAILED DESCRIPTION OF THE PREFERRED EMBODIMENTS

The wire shear anvil tool of the invention provides shearing of wires of differing diameters to provide clean cut ends to the wire. The tool of the invention cuts wire at a right angle and avoids the rocking and bending of the wire during shearing which in turn avoids fraying of the wire ends. Frayed ends, in addition to being sharp and able to cut a user, also have lessened conductivity. The wire shear anvil tool of the invention is structured to be portable and, therefore, useful in various locations, stable in use, and uncomplicated to use, but also provides for a clean cut. The tool can be handheld in itself or by another tool, (e.g., a ratchet tool, a vise grip or clamping tool, or the like) or held by a support bracket which can be affixed to a work bench or the like.

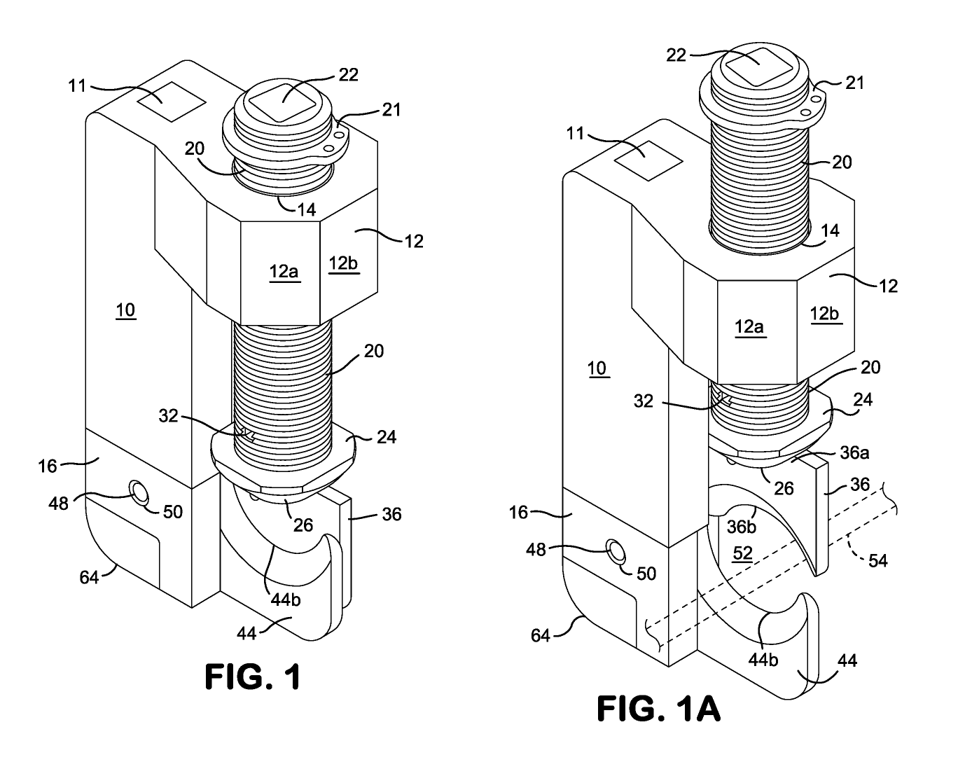

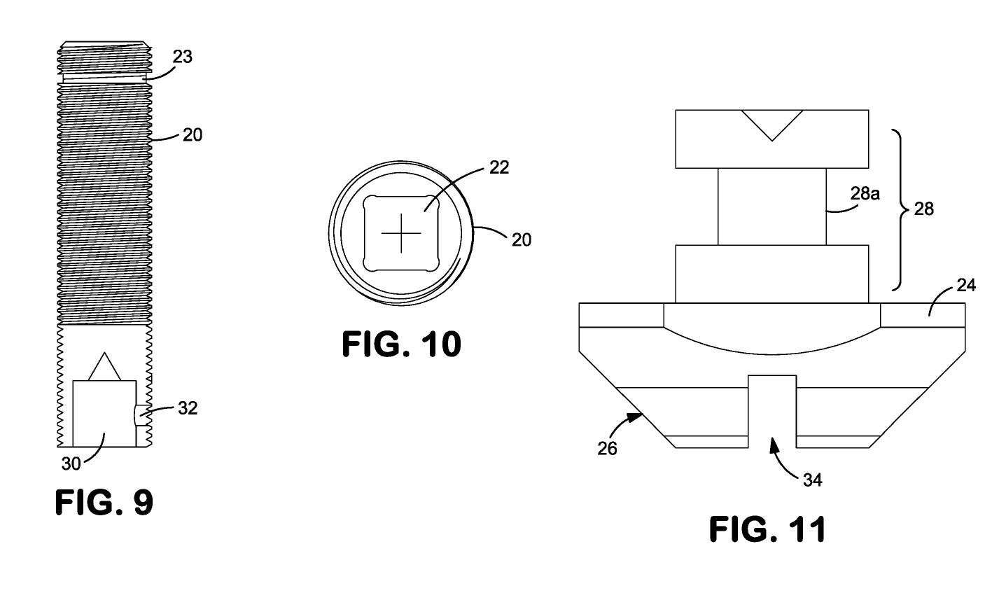

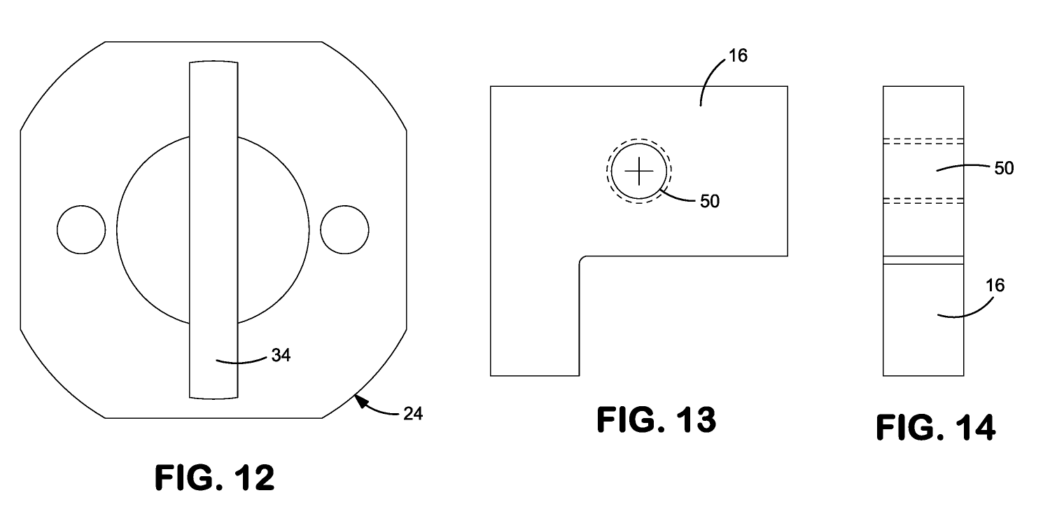

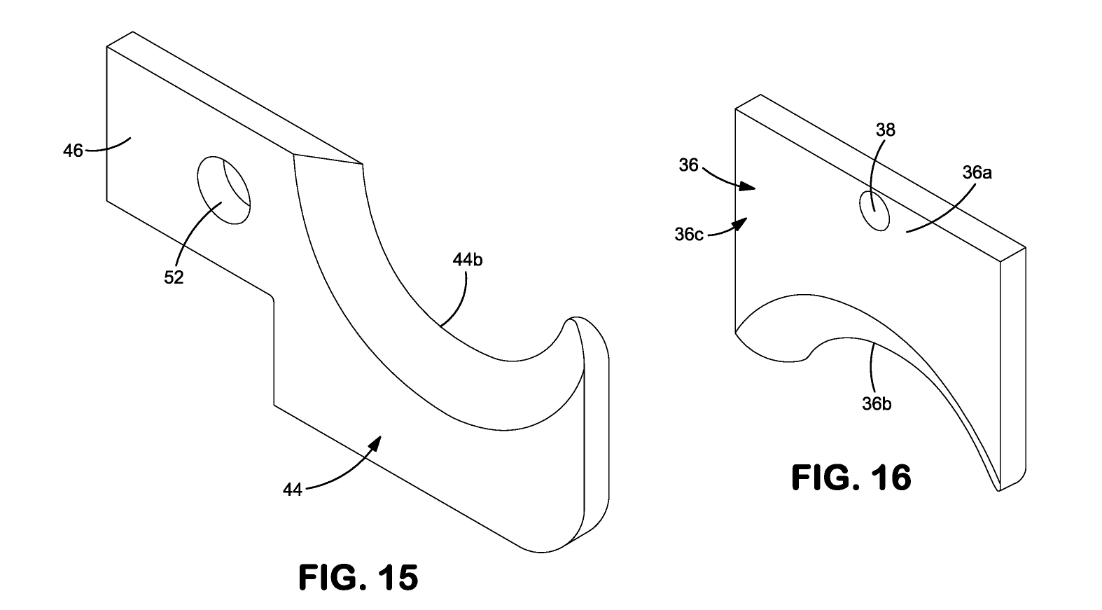

FIGS. 1-5 show a preferred embodiment of the portable shear anvil tool of the invention. The tool includes a main body 10 having an outward projecting extension 12 with a threaded opening 14 therein. The extension 12 preferably has a plurality of flat faces (for example sides 12a and 12b) to allow for a ready and stable grip by another tool, such as a wrench or vise grip. The main body further includes a lock piece 16 seated in a mating recess 18 in the main body 10 (see, e.g., FIG. 8). A threaded plunger 20 is received in threaded passage 14 which extends through extension 12. The threads of passage 14 and of the plunger 20 are complementary so that upon rotation, threaded plunger 20 moves upward and downward in passage 14 in response to the direction of rotation. The first or upper (as shown in the figures) end of the threaded plunger can have a thread lock 21 thereon to limit the downward movement of threaded plunger 20 into passage 14. Thread lock 21 can sit in a recess 23 (see FIG. 9) of threaded plunger 20. A ratchet-receiving opening 22 is provided in the top end of threaded plunger 20. A ratchet or extension of a ratchet tool can be received in opening 22 and used to rotate in a desired direction the threaded plunger 20 to move the plunger in a corresponding upward or downward movement during use of the wire shear anvil tool as further described below.

At the second or downward (as shown in the figures) end of threaded plunger 20 is a shear plunger 24. Shear plunger 24 includes a head 26 and upward extending projection 28 (see FIG. 11) sized to fit in an opening 30 (see FIG. 9) of threaded plunger 20. The projection 28 may be sized and/or shaped to provide a friction fit of the shear plunger 24 in opening 30, or alternatively, a fastening element can be provided through a hole, such as 32 in threaded plunger 20, to engage a side of projection 28, e.g., side 28a, to hold the shear plunger 24 in place at the end of threaded plunger 20. Alternatively, threaded plunger 20 and shear plunger 24 can be made as one piece.

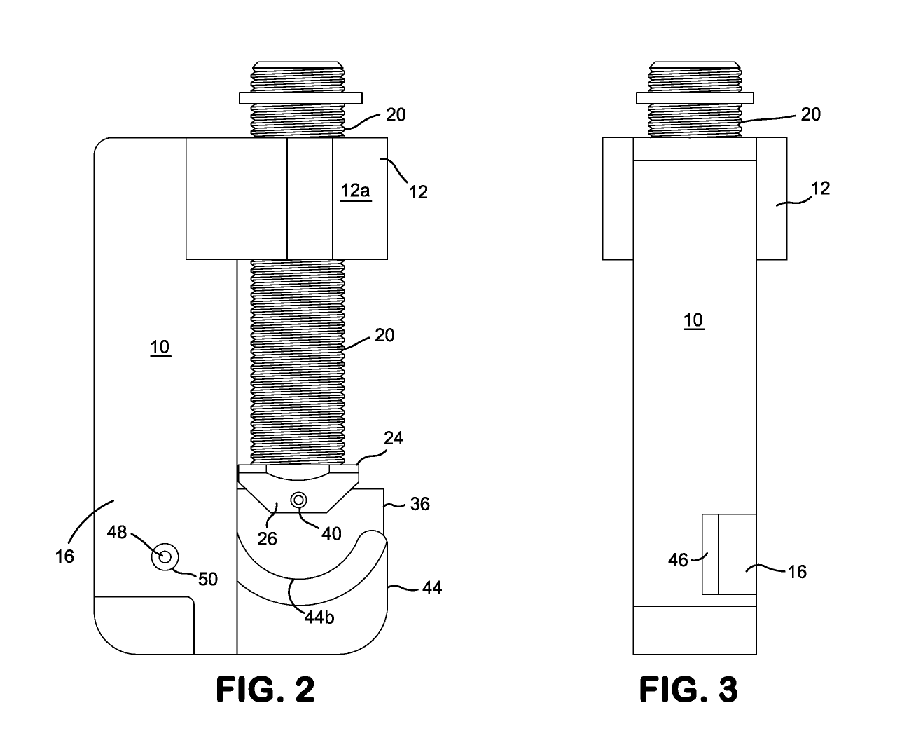

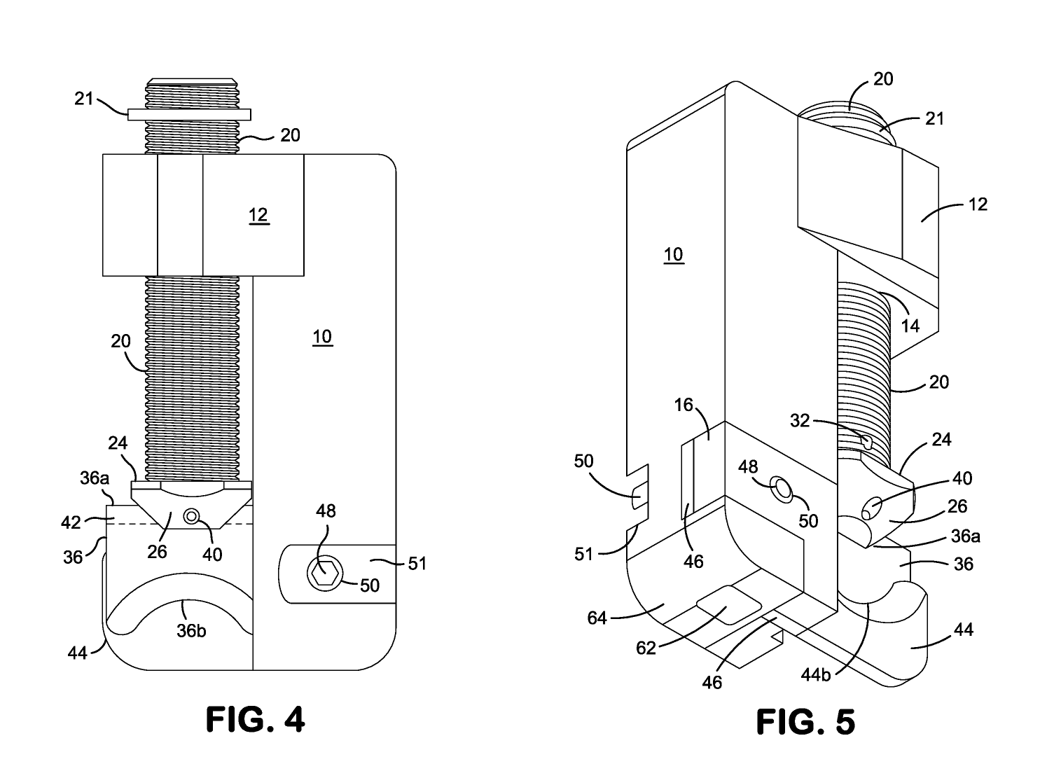

Head 26 of shear plunger 24 includes a recess or groove 34 for receiving a top end portion 36a of an upper shear blade 36. The top end portion 36a of blade 36 includes an opening 38 therein. Head 26 of shear plunger 24 includes a tapped hole 40 which extends from one side of head 26 (see FIG. 2) through the head of the shear plunger to the opposite side of head 26 (see FIG. 4). The tapped hole 40 is positioned in head 26 to be aligned with opening 38 in the top end portion 36a of upper shear blade 36 when the top end portion 36a is seated in groove 34. A fastening element is passed through tapped hole 40 and opening 38 to retain shear blade 36 in an operative position in relation to shear plunger 24. If desired to further insure a tight fit and, therefore, tight hold to prevent movement of the upper blade during use, a shim 42 (see FIG. 4, where shim 42 is shown in dashed lines) may also be positioned in groove 34. The shim can be of any appropriate material, but preferably is a strip of metal of appropriate thickness. The shim is used to provide a better fit and hold of the shear blade 36 and, thus, the shear end portion 36b, to provide a right angle cut to achieve a clean cut of a wire.

In view of the connection of shear blade 36 to shear plunger 24, shear blade 36 moves upward or downward corresponding to the movement of threaded plunger 20. Preferably main body 10 includes an elongated recess or groove 62 (see FIG. 8). Groove 62 is sized to receive a side edge portion 36c of the upper shear blade 36 so that groove 62 acts as a guide groove and provides additional stability to upper shear blade 36 during use of the tool. The groove further insures against undesired movement of the upper shear blade 36 so that a clean right angle cut is provided in a wire.

Extending outward from main body 10 and positioned below upper shear blade 36 is a lower shear blade or anvil 44. Lower shear blade or anvil 44 is maintained in a fixed position in the wire shear anvil tool to provide a consistently clean cut in combination with upper shear blade 36. Lower shear blade or anvil 44 is maintained in a fixed position by placement of extension 46 of lower shear blade 44 in recess 18 (see FIG. 8) of main body 10 where the extension 46 is held in position therein by lock piece 16 and a fastening element 48, e.g., a threaded screw, which extends through a passage 50 in main body 10 and a hole 52 in extension 46 of blade 44. Passage 50 and hole 52 are aligned when in place in main body 10 to allow for the passing of a common fastening element 48 therethrough. Preferably the fastening element is an Allen screw or the like with a flat head. Since an end of the fastening element 48 may extend outward of the main body 10, such as if it has a screw head, preferably the side of the main body having the projecting screw end will include a recessed area 51 to prevent the screw from projecting outward of the main body (see FIG. 4).

In use of the wire shear anvil tool to shear a wire, a ratchet tool or impact drill is used to engage ratchet-receiving opening 22 to rotate the threaded plunger 20 in an appropriate direction to move the threaded plunger 20 upward, which in turn moves shear plunger and with it upper shear blade 36 upward to provide a space 52 (see FIG. 1A) between the upper shear blade 36 and lower shear blade or anvil 44. A wire 54 (shown in dashed lines in FIG. 1A) to be sheared is positioned in space 52 and the ratchet tool used to reverse rotation of threaded plunger 20 causing downward or closing movement of threaded plunger 20, shear plunger 24 and upper shear blade 36 which causes shear end portion 36b to move in passing alignment with shear end portion 44b of lower shear blade 44 when upper shear blade 36 moves alongside lower shear blade 44. The pressure force provided on wire 54 as the shear end portions 36b and 44b serve to hold the wire between the blades 36 and 44 and then to shear the wire 54 as shear end portions 36b and 44b pass adjacent each other and move into the closed position as shown in FIG. 1.

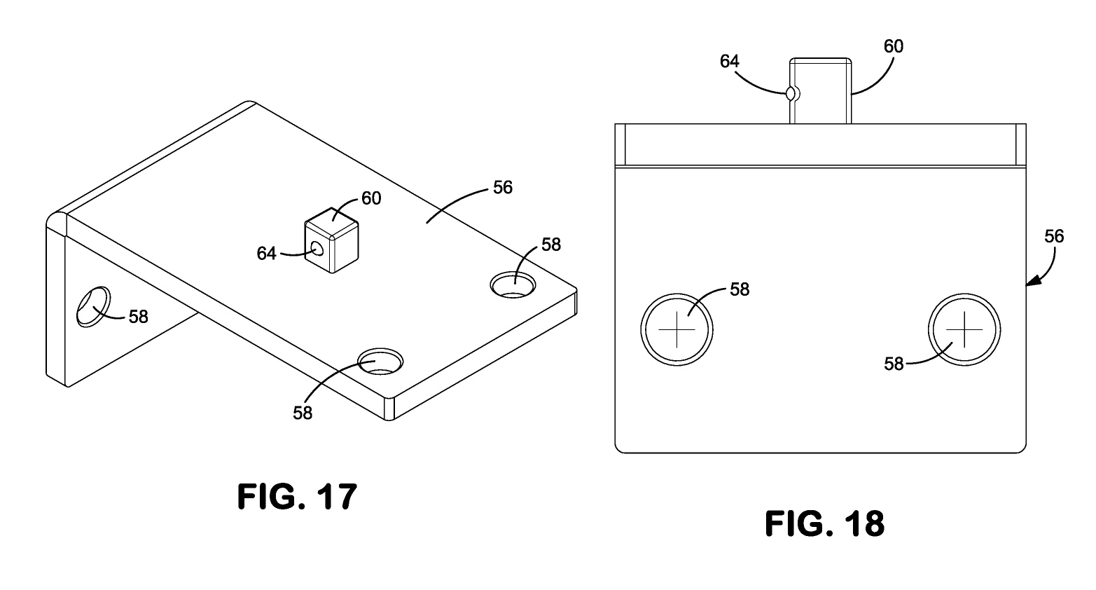

When the wire shear anvil tool is being used as a handheld tool, the main body 10 can be held by a ratchet tool or wrench using a recess 11 or recess 62 provided in the top end and bottom end of main body 10, or extension 12. Examples of such holding tools, but not limited thereto, are a ⅜ inch drive extension or ratchet as well as a 19 millimeter or ¾ inch open end wrench. Alternatively, the wire shear anvil tool can be used with a support bracket 56 as shown in FIGS. 17 and 18. The support bracket can be L-shaped so as to sit on the edge of a work bench or other surface. Holes 58 can be provided to receive screws or the like to fasten the support bracket to a work surface. The use of the support bracket frees up a hand of the user when using the tool. The bracket can include other attachment means to hold the support piece to a work surface, such as a clamp or snap-on element, which may allow for relocation of the bracket in a quicker and easier manner.

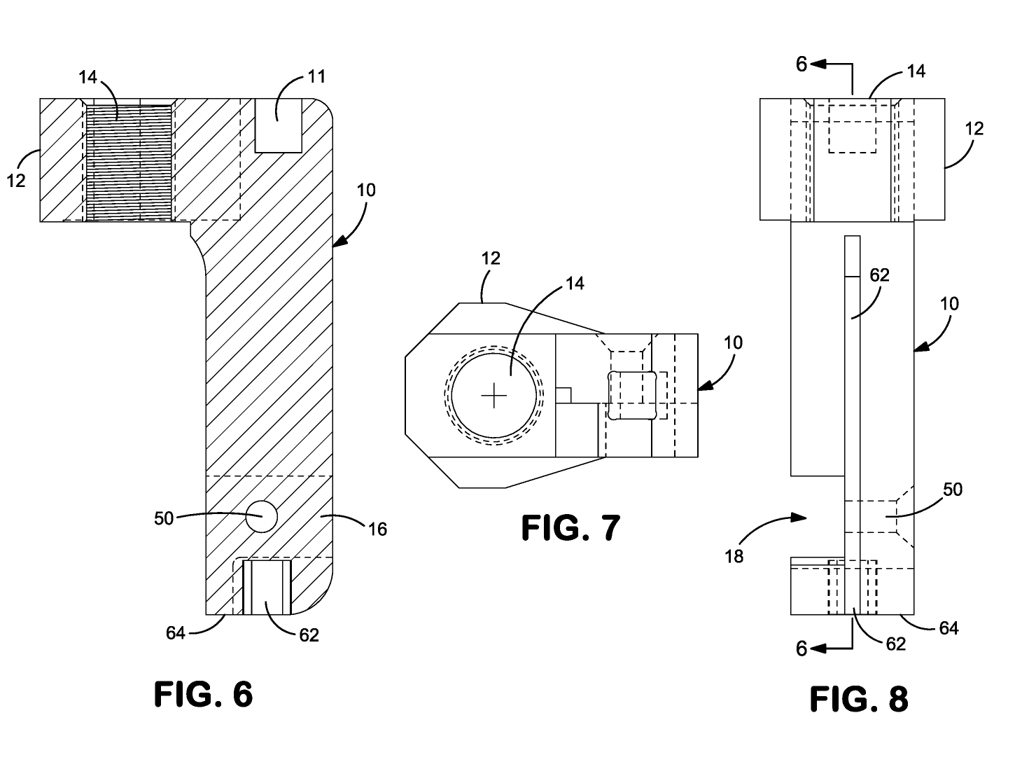

The wire shear anvil tool is removably connected to the support bracket 56 by means of upraised post 60 and recess 62 in the base 64 of the main body 10 (see FIGS. 5, 6 and 8). Post 60 and recess 62 can be of any complementary shape which can provide a friction fit in itself or, preferably post 60 includes a spring loaded ball detent 64 on center of a side wall of the post which provides pressure against a side wall of a recess 62 to retain the tool on the support bracket during use, but allows the tool to be removed from the support to allow use of the tool in different locations.

An alternative means of support is a conventional vise or vise grip tool. The jaws of the vise can hold the main body while the tool is used.

The shear blades 36 and 44 of the tool are preferably made of a hardened alloy steel. The main body, threaded plunger and shear plunger are preferably made of tempered steel. Other suitable materials, however, may be used without departing from the scope of the invention.

Tools suitable for use in rotation of the threaded plunger 20 include a ratchet tool or impact drill, for example, a ⅜ inch ratchet or ⅜ inch impact tool, as are conventionally available. These allow for use of the wire shear anvil tool of the invention to be readily useful without need for a specialty tool.

The exemplary embodiments herein disclosed are not intended to be exhaustive or to unnecessarily limit the scope of the invention. The exemplary embodiments were chosen and described in order to explain the principles of the present invention so that others skilled in the art may practice the invention. As will be apparent to one skilled in the art, various modifications can be made within the scope of the aforesaid description. Such modifications being within the ability of one skilled in the art form a part of the present invention and are embraced by the appended claims.

It is claimed:

1. A portable wire shear anvil tool comprising
(a) a main body including an outward extension having a threaded passage therethrough, and a lock piece;
(b) a threaded plunger adapted to be received in and move in the threaded passage in the outward extension of the main body, said threaded plunger including a tool receiving opening in a first end thereof;
(c) a shear plunger at a second end of said threaded plunger;
(d) an upper shear blade fastened to said shear plunger so as to move with the shear plunger; and
(e) a lower shear blade fixed in place to said main body by said lock piece.

2. The portable wire shear anvil tool according to claim 1 further comprising a thread lock at or adjacent the first end of said threaded plunger, said thread lock being adapted to limit movement of said threaded plunger into said threaded passage.

3. The portable wire shear anvil tool according to claim 1 wherein said main body includes a guide groove in which one side edge of said upper shear blade is received in and adapted to move in upon movement of the threaded plunger.

4. The portable wire shear anvil tool according to claim 1 wherein said tool receiving opening in said threaded plunger is adapted to receive a ratchet tool for providing downward and upward movement of said threaded plunger in said threaded passage in said outward extension.

5. The portable wire shear anvil tool according to claim 1 wherein said second end of said threaded plunger includes an opening adapted to receive and hold said shear plunger.

6. The portable wire shear anvil tool according to claim 1 further comprising a support bracket including a fastening element for retaining in an operative position said portable wire shear anvil tool on said support bracket.

7. The portable wire shear anvil tool of claim 6 wherein said fastening element is an upraised post having a spring loaded ball detent on one side of the post.
